(19) United States
(12) Patent Application Publication
(10) Pub. No.: US 2018/0342831 A1
(43) Pub. Date: Nov. 29, 2018

(54) CONNECTOR

(71) Applicant: YAZAKI CORPORATION, Tokyo (JP)

(72) Inventors: Tooru Kobayashi, Shizuoka (JP); Hisaya Shibata, Shizuoka (JP)

(21) Appl. No.: 15/960,502

(22) Filed: Apr. 23, 2018

(30) Foreign Application Priority Data
May 25, 2017 (JP) 2017-103959

(51) Int. Cl. H01R 13/52

(52) U.S. Cl. CPC H01R 13/5208; H01R 43/20

(57) ABSTRACT

A connector includes a terminal, a housing having a terminal accommodating chamber and a waterproofing member including an insertion hole through which the terminal passes. The terminal is inserted into the terminal accommodating chamber in a predetermined posture from a rear side. The waterproofing member includes a guide portion and a posture correcting portion. The guide portion is provided at least on a rear side in a terminal insertion direction in the insertion hole, and has a tapered shape so as to guide the terminal to the insertion hole. The posture correcting portion is provided in the guide portion, and is configured to correct a posture of the terminal about an axis of the insertion hole to the predetermined posture by abutting on the terminal to be inserted to the insertion hole.

### CROSS REFERENCE TO RELATED APPLICATIONS

This application is based on Japanese Patent Application (No. 2017-103959) filed on May 25, 2017, the contents of which are incorporated herein by way of reference.

### BACKGROUND

The present invention relates to a connector which is provided with a waterproofing member.

There is known a connector which includes a housing provided with a terminal accommodating chamber which stores a terminal connected to an end of an electric wire, a waterproofing member which is provided on a rear side of the housing to seal a gap between the electric wire and the housing, and a waterproofing member cover which is used to assemble the waterproofing member and the housing (for example, see JP-A-7-282892, JP-A-2008-84671, JP-A-2012-243739, JP-A-2014-2978, JP-A-2014-220058, and JP-A-2016-225045).

### SUMMARY

It is one advantageous aspect of the present invention to provide a connector which is able to make the insertion operation of a terminal smooth and secure.

According to one aspect of the invention, there is provide a connector including:

a terminal connected to an end of an electric wire;

a housing including a terminal accommodating chamber to which the terminal is inserted in a predetermined posture from a rear side; and

a waterproofing member which including an insertion hole through which the terminal passes, and mounted on a rear side of the housing to seal a gap between the housing and the electric wire extending from the terminal passed through the insertion hole, wherein

the waterproofing member includes

a guide portion provided at least on a rear side in a terminal insertion direction in the insertion hole, and having a tapered shape so as to guide the terminal to the insertion hole, and

a posture correcting portion provided in the guide portion, and configured to correct a posture of the terminal about an axis of the insertion hole to the predetermined posture by abutting on the terminal to be inserted to the insertion hole.

The terminal may include an electrical connection portion having a rectangular shape in cross-sectional view and configured to be electrically connected to a mating terminal, and the posture correcting portion may include a convex portion which protrudes in correspondence with a position along a side in the cross-sectional shape of the electrical connection portion.

The connector may further include a waterproofing member cover including a through hole through which the terminal passes, and holding the waterproofing member in the housing, and the guide portion may be configured to guide the terminal passed through the through hole to the insertion hole of the waterproofing member in a state where inclining of the electrical connection portion about the axis of the insertion hole is suppressed to be less than 45° with respect to the predetermined posture.

### BRIEF DESCRIPTION OF DRAWINGS

FIG. 1 is an exploded perspective view of a connector according to an embodiment of the invention;

FIG. 2 is a perspective view and a partially enlarged view of the housing illustrated in FIG. 1 when viewed from the rear side;

FIGS. 3A and 3B are an enlarged perspective view and a front view of the mat seal illustrated in FIG. 1;

FIGS. 4A and 4B are views for describing an insertion hole of the mat seal illustrated in FIGS. 3A and 3B, in which FIG. 4A is an enlarged view of portion A in FIGS. 3A and 3B, and FIG. 4B is a cross-sectional view taken along line B-B in FIG. 4A;

FIG. 5 is a rear view of the mat seal cover illustrated in FIG. 1;

FIGS. 6A and 6B are views for describing a structure of a terminal, in which FIG. 6A is a perspective view of the terminal, and FIG. 6B is a front view of the terminal;

FIG. 7 is a cross-sectional view illustrating a part of a connector for describing a storage state of the terminal;

FIG. 8 is an enlarged perspective view of the mat seal and main parts of the terminal for describing a posture correction of the terminal performed by a posture correcting portion;

FIG. 9 is a front view of the insertion hole when the terminal is in cross-sectional view in a state where the terminal is inserted to the insertion hole of the mat seal;

FIGS. 10A and 10B are views illustrating a modification of the posture correcting portion provided in the insertion hole of the mat seal, in which FIG. 10A is a front view of the insertion hole, and FIG. 10B is a cross-sectional view taken along line C-C in FIG. 10A;

FIGS. 11A to 11C are views illustrating the mat seal of the related art, in which FIG. 11A is a front view of the mat seal, FIG. 11B is a cross-sectional view taken along line D-D in FIG. 11A, and FIG. 11C is an enlarged view of portion E in FIG. 11B;

FIG. 12 is a partially cross-sectional view of the connector which is provided with the mat seal illustrated in FIGS. 11A to 11C, and

FIG. 13 is a perspective view of a terminal accommodating chamber of the housing illustrated in FIG. 12 and the terminal which is sent to the terminal accommodating chamber in a state where the posture is collapsed.

### DETAILED DESCRIPTION OF EXEMPLIFIED EMBODIMENTS

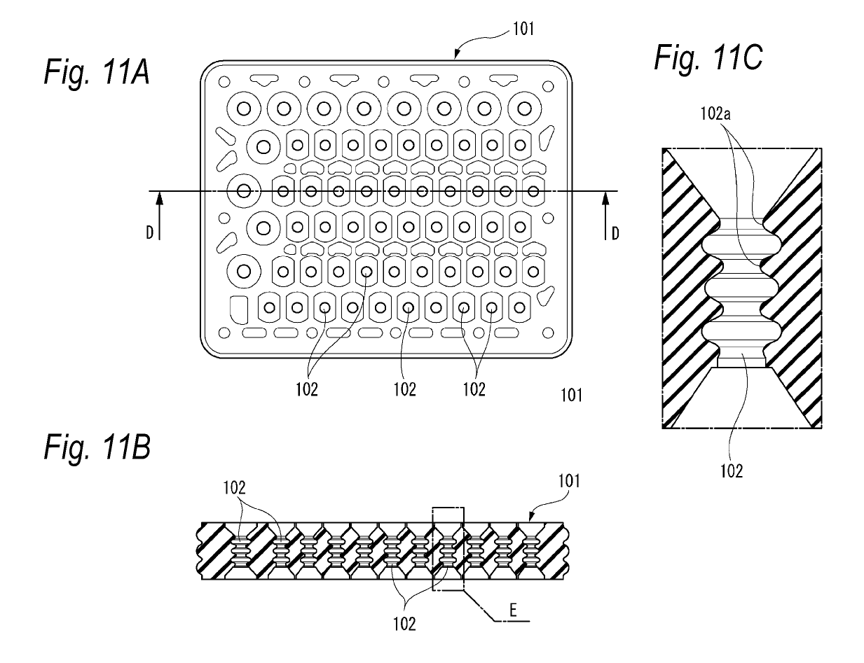

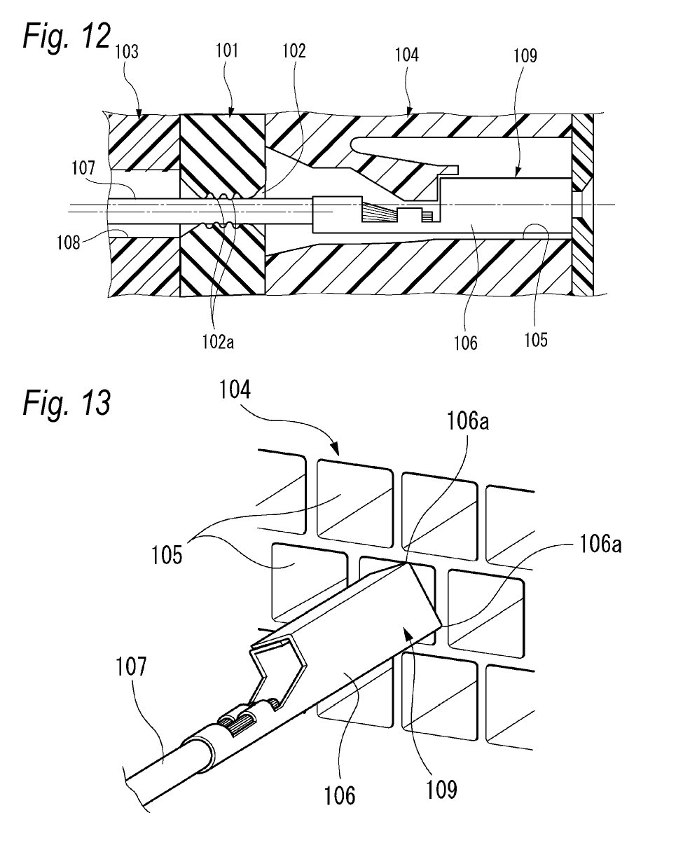

As illustrated in FIGS. 11A to 11C, a mat seal (waterproofing member) 101 includes a plurality of insertion holes 102 which pass through the front and rear surfaces. As illustrated in FIG. 12, the mat seal 101 is assembled to a housing 104 by a mat seal cover (waterproofing member cover) 103. A lip 102a formed in the inner periphery of the insertion hole 102 tightly adheres to the outer periphery of an electric wire 107 which extends from a female terminal 106 stored in a terminal accommodating chamber 105 of the housing 104, so that a gap between the electric wire 107 and the housing 104 are sealed. In the connector having such a configuration, the female terminal 106 stored in the terminal accommodating chamber 105 of the housing 104 is inserted from a through hole 108 of the mat seal cover 103 while an electrical connection portion 109 formed in a rectangular cylinder shape to which a mating male terminal is inserted and connected is set to face the front side. Then, the female terminal is passed through the insertion hole 102 of the mat seal 101 and sent to the terminal accommodating chamber 105.

By the way, when the female terminal 106 is inserted to the insertion hole 102 of the mat seal 101 in process of storing the female terminal 106 in the terminal accommodating chamber 105, there is a concern that the female terminal 106 is rotated about an axis and the posture is collapsed. Then, as illustrated in FIG. 13, a corner 109a of the electrical connection portion 109 of the female terminal 106 passed through the insertion hole 102 of the mat seal 101 comes into conflict with the edge of the rectangular terminal accommodating chamber 105 of the housing 104. Therefore, there is a concern that the female terminal 106 cannot be smoothly inserted to the terminal accommodating chamber 105, and it takes time in an insertion operation of the female terminal 106.

The invention has been made in view of the problem, and an object thereof is to provide a connector which is able to make the insertion operation of a terminal smooth and secure.

Hereinafter, embodiments of a connector according to the invention will be described with reference to the drawings.

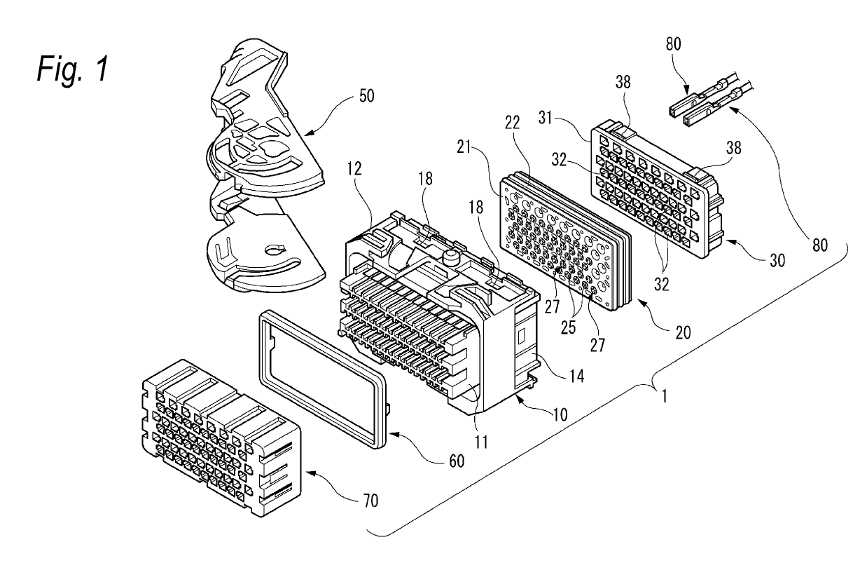

FIG. 1 is an exploded perspective view of a connector 1 according to an embodiment of the invention.

As illustrated in FIG. 1, the connector 1 according to the embodiment includes a synthetic resin housing 10, a rubber or flexible resin mat seal (waterproofing member) 20 which is fitted to the rear portion of the housing 10, a synthetic resin mat seal cover (waterproofing member cover) 30 which is fitted and fixed to the rear portion of the housing 10 to prevent falling from the rear side of the mat seal 20 while pressing, a synthetic resin lever 50 which is rotatably mounted on the outer side of the housing 10, a packing 60 which is mounted in the housing 10 from the front side, a front holder 70 which is mounted in the front portion of the housing 10, and a plurality of female terminals (terminals) 80 which are stored in the housing 10 from the rear side.

The connector 1 is a waterproofing connector which seals a gap between an electric wire 81 and the housing 10 by the mat seal 20 which is mounted in the rear portion of the housing 10. The connector 1 rotates the lever 50 which is rotatably mounted in the housing 10 to pull the housing of a mating connector to the housing 10. Therefore, the mating connector is joined to the connector 1 with a low insertion force. In this way, the connector 1 is a waterproofing connector, and serves as an LIF connector which joins the mating connector by an operation of the lever 50 with a low insertion force.

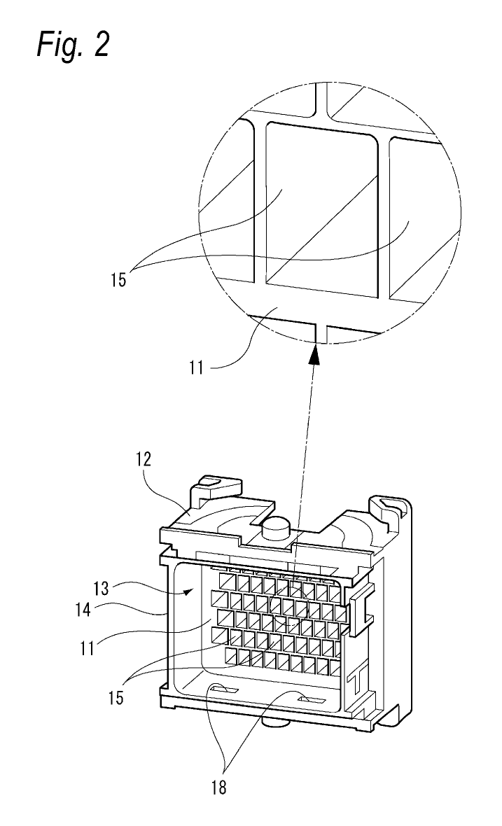

As illustrated in FIGS. 1 and 2, the housing 10 includes an inner housing 11 on an inner peripheral side which includes a plurality of terminal accommodating chambers 15 storing the female terminals 80, an outer housing 12 on an outer peripheral side, and a cylindrical wall 14 which is disposed on a rear side of the inner housing 11 and the outer housing 12.

The terminal accommodating chamber 15 is formed in a rectangular shape in front view. The female terminal 80 having an electrical connection portion 82 which is formed in a rectangular cylinder shape and in a rectangular shape in cross-sectional view and electrically connected to a mating terminal is inserted and stored in the terminal accommodating chamber 15 in a predetermined posture.

The outer housing 12 is a portion to be locked to the outer periphery of a locking cylindrical wall of the housing of the mating connector (not illustrated). The inner housing 11 is a portion to be locked to the inner periphery of the locking cylindrical wall of the housing of the mating connector. The rear end of the outer housing 12 is bound to the rear end of the inner housing 11 and the front end of the cylindrical wall 14. The cylindrical wall 14 is formed with a storage space 13 to store the mat seal 20 and the mat seal cover 30.

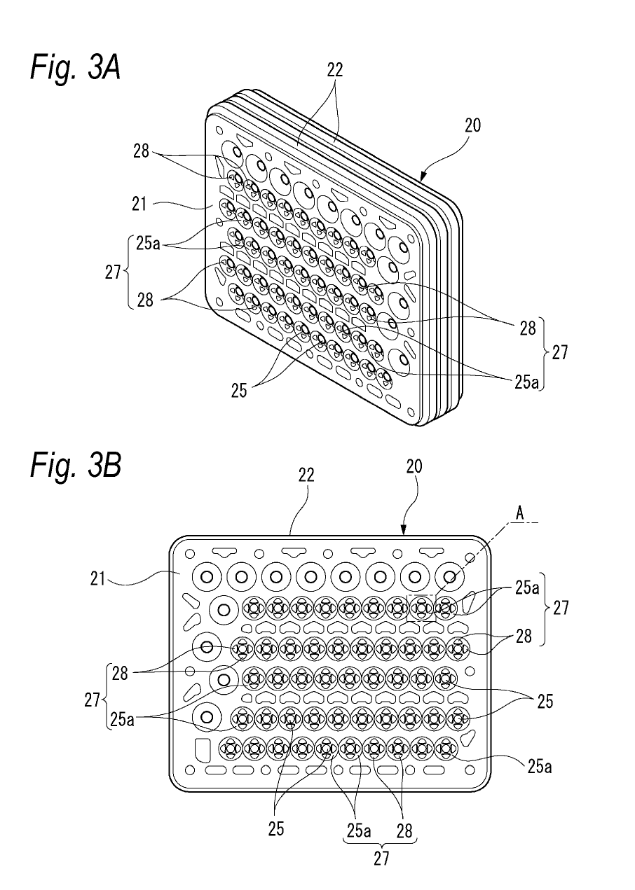

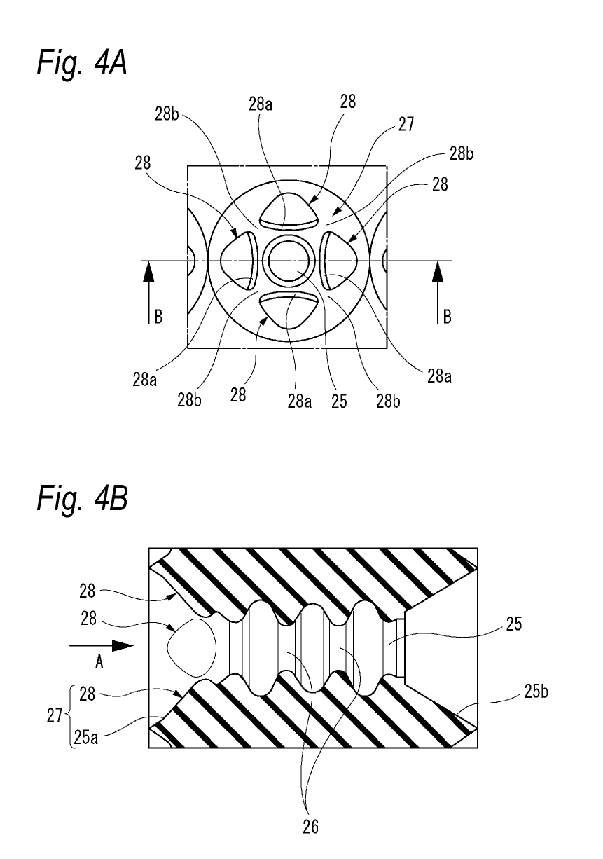

FIGS. 3A and 3B are an enlarged perspective view and a front view of the mat seal 20 illustrated in FIG. 1. FIGS. 4A and 4B are views for describing an insertion hole of the mat seal 20 illustrated in FIGS. 3A and 3B, in which FIG. 4A is an enlarged view of portion A in FIGS. 3A and 3B, and FIG. 4B is a cross-sectional view taken along line B-B in FIG. 4A.

As illustrated in FIGS. 3A and 3B, the mat seal 20 includes a lip 22 in the outer periphery of a mat body 21. The lip 22 seals a gap formed with respect to the cylindrical wall 14 when the mat body 21 is fitted to the inner periphery of the cylindrical wall 14 of the rear portion of the housing 10. Insertion holes 25 are formed to pass through the mat seal 20 at positions corresponding to the respective terminal accommodating chambers 15 of the housing 10 of the mat body 21. The mat seal 20 is configured such that the inner peripheries of the respective insertion holes 25 tightly adhere to the outer peripheries of the electric wires 81 extending from the respective female terminals 80 toward the rear side when the female terminals 80 are respectively inserted to the terminal accommodating chambers 15 through the insertion holes 25 in the state of being fitted to the inner periphery of the cylindrical wall 14 having the storage space 13 formed in the rear portion of the housing 10. Therefore, the electric wires 81 and the housing 10 are integrally sealed.

As illustrated in FIGS. 4A and 4B, in the inner surface of the insertion hole 25, a plurality of inner peripheral lips 26 protrude in an inner peripheral direction along the peripheral direction and are arranged with an interval in the axial direction. On the rear side and the front side of a terminal insertion direction A in the insertion hole 25, tapered guide portions 25a and 25b which face to the center in the axial direction of the insertion hole 25 and are tapered are formed. The insertion hole 25 having the inner peripheral lip 26 is pressed and widened by the inserted female terminal 80, and tightly adheres to the outer periphery of the electric wire 81 after passing through the female terminal 80.

The mat seal 20 includes a posture correcting portion 27 on the rear side of the terminal insertion direction A in the insertion hole 25, that is, in the guide portion 25a on the insertion side of the female terminal 80. The posture correcting portion 27 includes a plurality (four in this example) of convex portions 28 which protrude from the surface of the guide portion 25a. These convex portions 28 are formed in pairs at positions facing each other with the insertion hole 25 interposed therebetween, and protrude in correspondence with positions along a side in the cross-sectional shape of the electrical connection portion 82. The convex portion 28 has a vertex portion 28a of which the center portion protrudes at a maximum in a width direction on the insertion hole 25 side, and smoothly inclined to the lower side from the vertex portion 28a to the periphery. With this configuration, a concave portion 28b is formed between the adjacent convex portions 28 in the posture correcting portion 27. These concave portions 28b are formed at positions corresponding to the corners of the terminal accommodating chamber 15 which is formed in a rectangular shape of the housing 10.

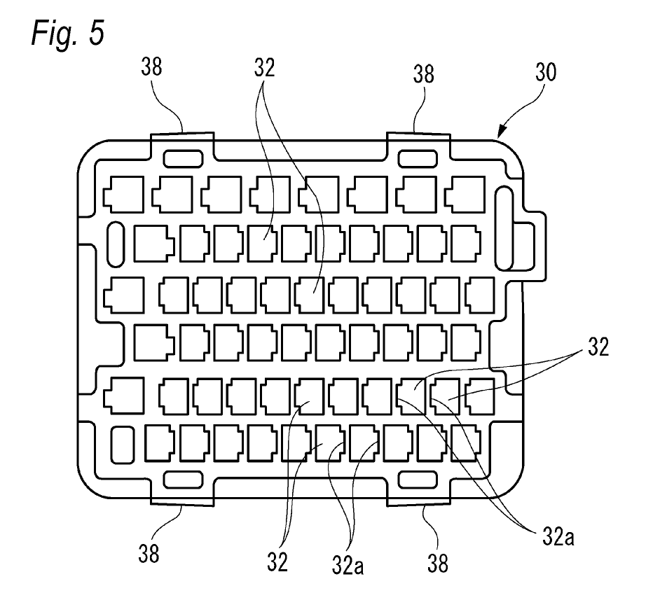

FIG. 5 is a rear view of the mat seal cover 30 illustrated in FIG. 1.

As illustrated in FIG. 1, the mat seal cover 30 is mounted to the rear end of the housing 10 through the mat seal 20 to perform a function of applying a pressing force to the mat seal 20 in order to prevent the mat seal 20 from being pulled off but held, and to exert a sufficient sealing performance. As illustrated in FIG. 5, in a cover body 31 of the mat seal cover 30 which is made of a molded synthetic resin part, there are provided a plurality of through holes 32 at positions corresponding to the respective insertion holes 25 of the mat seal 20 to insert the female terminal 80 thereinto and to draw the electric wire 81 toward the rear side. The through hole 32 is formed in a rectangular shape in front view. The female terminal 80 having the electrical connection portion 82 formed in a rectangular cylinder shape, and in a rectangular shape in cross-sectional view is inserted to the through hole 32. In the through hole 32, a positioning concave portion 32a is formed in a portion of the inner peripheral surface along the axial direction. The through hole 32 of the mat seal cover 30 formed as above causes the inserted female terminal 80 to pass through while suppressing the inclining of the electrical connection portion 82 about an axis of the insertion hole 25 to be less than 45° forward and backward.

A locking portion 38 is formed in the periphery of the mat seal cover 30. The locking portion 38 is locked to a locking hole 18 (see FIG. 2) which is formed in the cylindrical wall 14 of the housing 10. The mat seal cover 30 is configured such that, when the locking portion 38 is locked to the locking hole 18, the mat seal 20 is prevented from being pulled off and the mat seal 20 is pressed into the cylindrical wall 14 so as to be held in the housing 10.

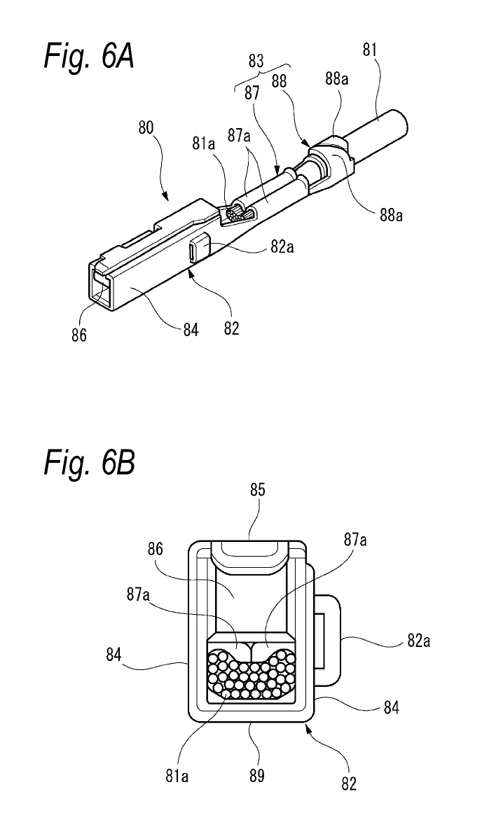

FIGS. 6A and 6B are views for describing a structure of the female terminal, in which FIG. 6A is a perspective view of the female terminal, and FIG. 6B is a front view of the female terminal.

As illustrated in FIGS. 6A and 6B, the electric wire 81 is connected to the female terminal 80. The female terminal 80 includes the electrical connection portion 82 and an electric wire connecting portion 83. The female terminal 80 is formed of a conductive metallic material such as copper or a copper alloy, and thus is formed by punching and bending in press molding.

The electrical connection portion 82 is formed in a rectangular cylinder shape which is a rectangular shape in cross-sectional view. The electrical connection portion 82 includes a bottom plate 89, side plates 84 which are erected from the both side portions of the bottom plate 89, and a top plate 85 which is provided to extend from the upper edge of one side plate 84 to the upper edge of the other side plate 84. In the top plate 85, an elastic contact piece 86 is formed. The elastic contact piece 86 is folded back inside on the front end side in the top plate 85 to extend toward the rear end side. The intermediate portion of the elastic contact piece 86 is bent to be projected toward the top plate 85 side. A slight gap is formed between the bottom plate 89 and the elastic contact piece 86. A male terminal (mating terminal) of the mating connector (not illustrated) is inserted between the bottom plate 89 and the elastic contact piece 86 in the electrical connection portion 82, and thus the female terminal 80 and the mating terminal are electrically connected to each other. The electrical connection portion 82 includes a positioning projection 82a in one side portion which protrudes to the outside. The positioning projection 82a is guided to the positioning concave portion 32a which is formed in the through hole 32 of the mat seal cover 30. With this configuration, the female terminal 80 is inserted to the through hole 32 of the mat seal cover 30 in a state of being positioned in a predetermined posture, and sent to the mat seal 20 and the housing 10.

The electric wire connecting portion 83 of the female terminal 80 includes a conductor crimping portion 87 and a sheath crimping portion 88 sequentially from the electrical connection portion 82 side. The conductor crimping portion 87 includes a pair of conductor caulking pieces 87a. The sheath crimping portion 88 includes a pair of sheath caulking pieces 88a. In the conductor crimping portion 87, a conductor 81a exposed at the end portion of the electric wire 81 is pressed by caulking the conductor caulking piece 87a. Therefore, the female terminal 80 is electrically connected to the conductor 81a of the electric wire 81. In the sheath crimping portion 88, the end portion of the sheath of the electric wire 81 is compressed and fixed by caulking the sheath caulking piece 88a.

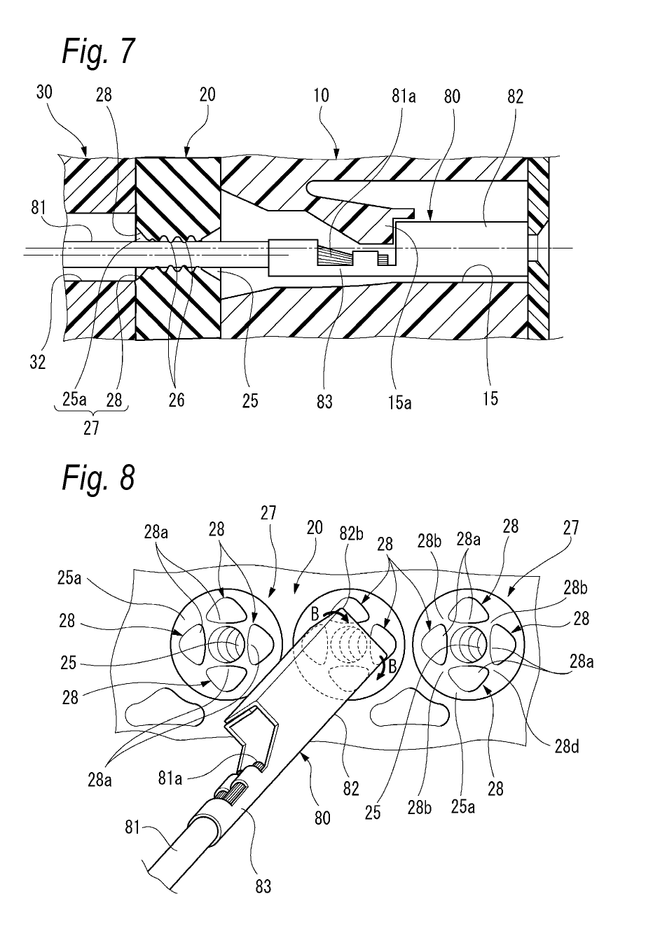

FIG. 7 is a cross-sectional view illustrating a part of the connector 1 for describing a storage state of the female terminal 80.

As illustrated in FIG. 7, the female terminal 80 mounted from the rear end of the connector 1 is stored in a state where the electrical connection portion 82 is locked by a lance 15a in the terminal accommodating chamber 15 of the housing 10. In this state, the inner peripheral lip 26 of the insertion hole 25 of the mat seal 20 tightly adheres to the outer periphery of the electric wire 81 connected to the female terminal 80, and thus a gap between the electric wire 81 and the housing 10 is sealed.

Next, the description will be given about a case where the female terminal 80 is assembled to the housing 10.

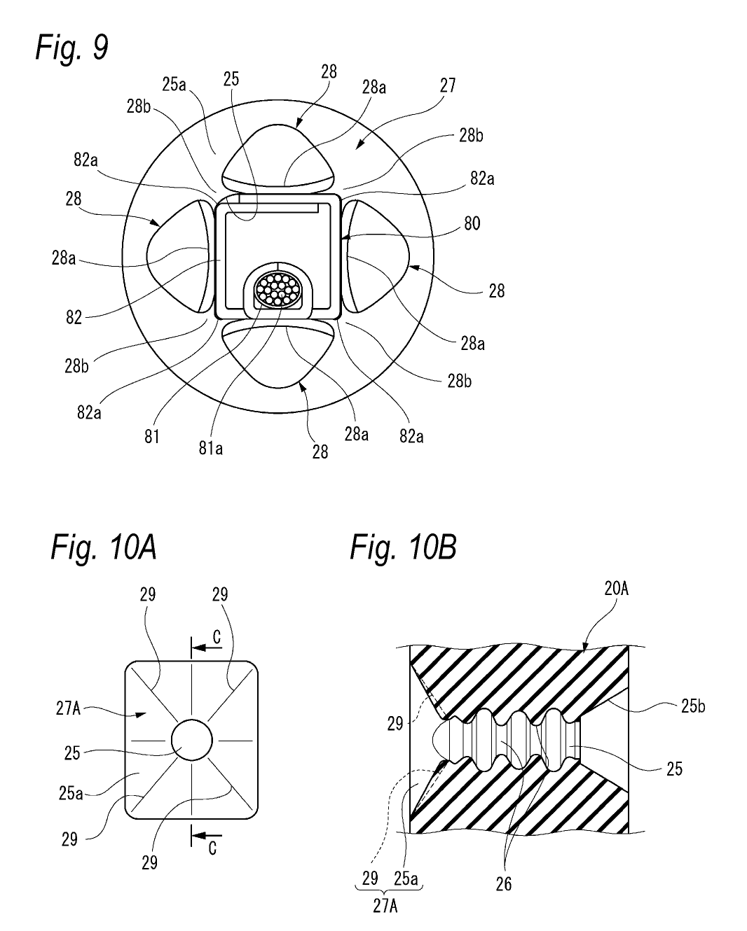

FIG. 8 is an enlarged perspective view illustrating the mat seal 20 and main parts of the female terminal 80 for describing a posture correction of the female terminal 80 by the posture correcting portion 27. FIG. 9 is a front view of the insertion hole 25 when the female terminal 80 is in cross-sectional view in a state where the female terminal 80 is inserted to the insertion hole 25 of the mat seal 20.

The position of the positioning projection 82a formed in the electrical connection portion 82 of the female terminal 80 is arranged to be matched up with the positioning concave portion 32a of the through hole 32 of the mat seal cover 30, and the female 80 is inserted into the through hole 32 from the rear side of the mat seal cover 30. With this configuration, the female terminal 80 is inserted through the through hole 32 of the mat seal cover 30 in a predetermined posture.

Further, the electrical connection portion 82 of the female terminal 80 is inserted to the insertion hole 25 of the mat seal 20 by inserting the female terminal 80.

At this time, as illustrated in FIG. 8, the female terminal 80 may be inserted to the insertion hole 25 of the mat seal 20 in a state where the female terminal is rotated about the axis to change the posture to be inclined. Then, the front end of the female terminal 80 abuts on the posture correcting portion 27 provided in the guide portion 25a on the insertion side of the female terminal 80 in the insertion hole 25. The posture is returned to a predetermined posture as standard when being stored in the terminal accommodating chamber 15 of the housing 10. Specifically, a corner 82b in the front end of the electrical connection portion 82 of the female terminal 80 which is formed in a rectangular cylinder shape, and in a rectangular shape in cross-sectional view abuts on the convex portion 28 of the posture correcting portion 27. Then, the corner 82b of the electrical connection portion 82 is guided to the concave portion 28b between the convex portions 28 adjacent along the inclining of the convex portion 28. With this configuration, the female terminal 80 is rotated in a direction (the direction of arrow B in FIG. 8) opposite to the direction of collapsing the posture, the convex portions 28 are disposed in correspondence with the position along the sides in the cross-sectional shape of the electrical connection portion 82 so as to return to a predetermined posture matched up with the terminal accommodating chamber 15 of the housing 10. Therefore, the female terminal 80 is inserted to the insertion hole 25 of the mat seal 20 in a predetermined posture.

As illustrated in FIG. 9, when the female terminal 80 is inserted to the insertion hole 25, the both side surfaces and the upper and lower surfaces (the outer peripheral surfaces) of the electrical connection portion 82 are held by the convex portion 28, and thus the predetermined posture is kept even in the middle of passing through the insertion hole 25. In this way, the female terminal 80 passed through the insertion hole 25 in a predetermined posture as standard is smoothly inserted to the terminal accommodating chamber 15 without interference to the edge of the terminal accommodating chamber 15 of the housing 10.

When the female terminal 80 passes through the insertion hole 25 of the mat seal 20, the inner peripheral lip 26 of the insertion hole 25 of the mat seal 20 evenly and tightly adheres to the outer peripheral surface of the electric wire 81 to seal the electric wire 81 and the housing 10.

Hitherto, as described above, according to the connector 1 of the embodiment, when the female terminal 80 is inserted to the insertion hole 25 of the mat seal 20, the posture of the female terminal 80 about the axis is corrected to a predetermined posture by the posture correcting portion 27.

Specifically, when the female terminal 80 of which the electrical connection portion 82 is formed in a rectangular shape in cross-sectional view is inserted to the insertion hole 25 of the mat seal 20, each side at the front end of the electrical connection portion 82 is along the convex portion 28 of the posture correcting portion 27, and each corner 82b at the front end of the electrical connection portion 82 is guided between the adjacent convex portions 28. Therefore, the posture of the female terminal 80 about the axis is corrected to the predetermined posture to be smoothly inserted to the insertion hole 25.

With this configuration, the front end of the female terminal 80 sent to the terminal accommodating chamber 15 of the housing 10 through the insertion hole 25 of the mat seal 20 does not come into conflict with the edge of the terminal accommodating chamber 15. Therefore, an insertion operation of the female terminal 80 to the terminal accommodating chamber 15 of the housing 10 can be smoothly and securely performed.

Even when the female terminal 80 passes through the insertion hole 25, the outer peripheral surface of the electrical connection portion 82 is held by the respective convex portions 28 of the posture correcting portion 27. Therefore, the female terminal 80 can be sent to the terminal accommodating chamber 15 of the housing 10 while keeping the posture stable.

By the way, if the female terminal 80 of which the electrical connection portion 82 is formed in a rectangular shape in cross-sectional view is inclined by equal to or more than 45° about the axis, the posture of the female terminal 80 is too collapsed and thus the posture correcting portion 27 of the mat seal 20 may hardly correct the posture of the female terminal 80 to the predetermined posture. In other words, if the inclining of the electrical connection portion 82 having a rectangular shape in cross-sectional view is equal to or more than 45° about the axis, the corner 82b of the electrical connection portion 82 is guided to the adjacent concave portion 28b different from the corresponding concave portion 28b, and thus the inclining of the female terminal 80 about the axis becomes 90°.

However, in the embodiment, the inclining of the electrical connection portion 82 passed through the through hole 32 of the mat seal cover 30 is suppressed to be less than 45° about the axis with respect to a predetermined posture. Therefore, the posture of the female terminal 80 is securely corrected to a predetermined posture by the posture correcting portion 27 of the mat seal 20, so that the female terminal can be sent to the terminal accommodating chamber 15 of the housing 10.

Further, the invention is not limited to the above embodiments, and modifications and improvements can be appropriately made. Besides, materials, shapes, dimensions, numbers, and layout places of the respective components in the above embodiments are arbitrary and not limited as long as the invention can be achieved.

For example, in the above embodiment, the posture correcting portion 27 having the plurality of convex portions 28 is provided in the guide portion 25a. However, like a mat seal 20A illustrated in FIGS. 10A and 10B, a groove 29 may be formed as a posture correcting portion 27A in the guide portion 25a to correct the female terminal 80 to be a predetermined posture by guiding the corner 82b of the electrical connection portion 82 to a standard position.

In the above embodiment, the posture correcting portion 27 is provided in the guide portion 25a on the insertion side of the female terminal 80 in the insertion hole 25. However, the posture correcting portion may be provided on both sides of the guide portions 25a and 25b of the insertion hole 25. In this case, the posture of the female terminal 80 can be corrected when the female terminal 80 is inserted to the insertion hole 25. Further, even when the female terminal 80 is pulled out of the insertion hole 25, the posture of the female terminal 80 can be corrected, and it is possible to suppress the interference between the female terminal 80 and the edge of the through hole 32 of the mat seal cover 30.

Herein, the features of the embodiments of the connector according to the invention will be simply summarized in the following [1] to [3].

[1] A connector (1), including:

a terminal (the female terminal 80) connected to an end of an electric wire (81);

a housing (10) including a terminal accommodating chamber (15) to which the terminal (the female terminal 80) is inserted in a predetermined posture from a rear side; and

a waterproofing member (the mat seal 20) including an insertion hole (25) through which the terminal (the female terminal 80) passes, and mounted on a rear side of the housing (10) to seal a gap between the housing (10) and the electric wire (81) extending from the terminal (the female terminal 80) passed through the insertion hole (25), wherein

the waterproofing member (the mat seal 20) includes

a guide portion (25a) provided at least on a rear side in a terminal insertion direction (A) in the insertion hole (25), and having a tapered shape so as to guide the terminal (the female terminal 80) to the insertion hole (25), and

a posture correcting portion (27) provided in the guide portion (25a), and configured to correct a posture of the terminal (the female terminal 80) about an axis of the insertion hole (25) to the predetermined posture by abutting on the terminal (the female terminal 80) to be inserted to the insertion hole (25).

[2] The connector (1) according to [1], wherein

the terminal (the female terminal 80) includes an electrical connection portion (82) having a rectangular shape in cross-sectional view and configured to be electrically connected to a mating terminal, and

the posture correcting portion (27) includes a convex portion (28) which protrudes in correspondence with a position along a side in the cross-sectional shape of the electrical connection portion (82).

[3] The connector (1) according to [2], further including:

a waterproofing member cover (the mat seal cover 30) including a through hole (32) through which the terminal (the female terminal 80) passes, and holding the waterproofing member (the mat seal 20) in the housing (10),

wherein the guide portion (25a) is configured to guide the terminal (the female terminal 80) passed through the through hole (32) to the insertion hole (25) of the waterproofing member (the mat seal 20) in a state where inclining of the electrical connection portion (82) about the axis of the insertion hole (25) is suppressed to be less than 45° with respect to the predetermined posture.

According to the connector, the posture of the terminal about the axis is corrected by the posture correcting portion to the predetermined posture when the terminal is inserted to the insertion hole of the waterproofing member. With this configuration, the front end of the terminal which passes through the insertion hole of the waterproofing member and sent to the terminal accommodating chamber of the housing does not come into conflict with the edge of the terminal accommodating chamber. Therefore, the insertion operation of the terminal to the terminal accommodating chamber of the housing can be performed smoothly and securely.

According to the connector, when the terminal of which the electrical connection portion is formed in a rectangular shape in cross-sectional view is inserted to the insertion hole of the waterproofing member, each side at the front end of the electrical connection portion is along the convex portions of the posture correcting portion, and each corner at the front end of the electrical connection portion is guided between the adjacent convex portions. With this configuration, the posture of the terminal about the axis is corrected to the predetermined posture and inserted to the insertion hole. Even when the terminal passes through the insertion hole, each outer peripheral surface of the electrical connection portion is held by each convex portion of the posture correcting portion. Therefore, the terminal can be sent to the terminal accommodating chamber of the housing while keeping the posture stable.

According to the connector of, if the inclining of the terminal of which the electrical connection portion is formed in a rectangular shape in cross-sectional view is equal to or more than 45° about the axis, the posture of the terminal is too collapsed and thus the posture correcting portion of the waterproofing member hardly correct the posture of the terminal to the predetermined posture. However, in the terminal passed through the through hole of the waterproofing member cover, the inclining of the electrical connection portion about the axis is suppressed to be less than 45° with respect to the predetermined posture, and thus the posture correcting portion of the waterproofing member can securely correct the posture of the terminal to the predetermined posture, and the terminal can be sent to the terminal accommodating chamber of the housing.

According to the invention, it is possible to provide a connector which is able to make an insertion operation of a terminal smooth and secure.

What is claimed is:

1. A connector comprising:
a terminal connected to an end of an electric wire;
a housing including a terminal accommodating chamber to which the terminal is inserted in a predetermined posture from a rear side; and
a waterproofing member which including an insertion hole through which the terminal passes, and mounted on a rear side of the housing to seal a gap between the housing and the electric wire extending from the terminal passed through the insertion hole, wherein
the waterproofing member includes
a guide portion provided at least on a rear side in a terminal insertion direction in the insertion hole, and having a tapered shape so as to guide the terminal to the insertion hole, and
a posture correcting portion provided in the guide portion, and configured to correct a posture of the terminal about an axis of the insertion hole to the predetermined posture by abutting on the terminal to be inserted to the insertion hole.

2. The connector according to claim 1, wherein
the terminal includes an electrical connection portion having a rectangular shape in cross-sectional view and configured to be electrically connected to a mating terminal, and
the posture correcting portion includes a convex portion which protrudes in correspondence with a position along a side in the cross-sectional shape of the electrical connection portion.

3. The connector according to claim 2, further comprising:
a waterproofing member cover including a through hole through which the terminal passes, and holding the waterproofing member in the housing,
wherein the guide portion is configured to guide the terminal passed through the through hole to the insertion hole of the waterproofing member in a state where inclining of the electrical connection portion about the axis of the insertion hole is suppressed to be less than 45° with respect to the predetermined posture.
